(19) United States
(12) Patent Application Publication
(10) Pub. No.: US 2012/0011039 A1
(43) Pub. Date: Jan. 12, 2012

(54) SYSTEM AND METHOD FOR SERVICES MANAGEMENT

(75) Inventors: Miroslav Cina, Hanhofen (DE); Banko Bantchev, Stuttgart (DE); Claus STEIMER, Weingarten (DE); Horst NEUNABER, Weisloch (DE)

(73) Assignee: SAP AG, Walldorf (DE)

(21) Appl. No.: 12/833,465

(22) Filed: Jul. 9, 2010

(51) Int. Cl. G06Q 40/00; G06Q 10/00

(52) U.S. Cl. 705/35

(57) ABSTRACT

Embodiments of a system, machine readable storage medium and a computer-implemented method for implementing a services management system for providing services to a recipient are disclosed. The system may include a computer application controller operating on a back end server accessible by a user application operating on a front end server. The back end server may generate a computer object in response to remote function calls performed by the user application operating on the front end server. Data in the remote function calls may contain data related to services approved for a particular recipient. The generated computer objects may be operated upon by processes executing on the back end server that calculate a gross entitlement amount of benefits for the recipient. The calculated amounts may be passed to a gross payment calculation object and a net calculation objects.

### REFERENCE TO RELATED APPLICATION

This Application incorporates by reference the entire contents of U.S. Non-Provisional application Ser. Nos. ______ (Atty Docket Nos. 11884/511401, 11884/511501, 11884/511601, 11884/511701, and 11884/511801) filed Jul. 9, 2010.

### FIELD

The disclosed subject matter relates to a system and method for providing a social services computer framework. In particular, the disclosed subject matter relates to a software architecture for an expanded social services framework that includes elements for performing calculations related to the entitlements, payments including net payments and billing for the provision of social service benefits.

### BACKGROUND

Modern enterprises such as governmental organizations and private businesses typically use computer systems to manage their operations. Enterprise management systems are computerized systems that define processes and protocols for various business operations. By using enterprise management systems, public and private organizations can define processes that are to be undertaken during performance of the organization's operations which can be applied uniformly among a large set of employees.

For example, in the case of public service social providers, an enterprise management system can be used to manage the provision of requested social services. In order to insure accurate distribution of social services benefits, the enterprise business systems may update the status of beneficiaries, the status of applicable laws and regulations including tax changes, status changes resulting from legislation and other aspects of the provided social services that may be subject to change.

When these updates are implemented, the effects of the updates may be to the benefits received by a single person or the entire population of people receiving social services. The social services benefits to be provided to a recipient may be stored in a social services plan (SSP) data structure. Once approved, the SSP may be implemented. An example of a system for generating and approving a social services plan is described in U.S. patent application Ser. No. 12/333,766 filed on Dec. 12, 2008, the entire contents of which are incorporated herein by reference. The calculation of the benefit amounts and tracking of the payments is commonly performed by another computer system that may be able to import from the existing enterprise management system some of the data related to a social service recipient and the amount of benefits that the recipient is to receive. In addition, when an overpayment of social service benefits is detected to have been provided to a recipient, the recipient cannot typically repay the amount overpaid in one lump sum. Accordingly, a repayment schedule may be developed by deducting a portion of the overpaid amount from future amounts of payments. This may be maintained as a social deduction plan (SDP), and may be coexistent with the social services plan (SSP).

Presently, any social services agency, e.g., a government, or government identified entity, has to develop or obtain their own software solution to calculate the amount of benefits a recipient is entitled, amounts that are paid, and calculating any overpayments, or, alternatively, the social service agency must perform the task manually. Existing systems that handle or transform entitlements into payments are typically confronted with critical performance and data volume problems. For example, a social service (e.g., pensions) is provided to a huge number of citizens for a long time (e.g., open-ended); and payments need to be periodically recalculated.

The inventors recognized a need for a comprehensive software framework executing on a computer system that performs both the application process and the payment processes for providing social services in a single services management system. In addition to social services, other forms of agencies or businesses may implement systems that require the determination of entitled benefits, gross payments and taxation or other deductions from the entitled benefits. For example, pension funds, entities that make payments according to a plan and/or entitlement, or the like may benefit from a system that performs similar functions.

### BRIEF DESCRIPTION OF THE DRAWINGS

FIG. 1 illustrates an exemplary computer system for implementing a social services system according to an exemplary embodiment.

FIG. 2 illustrates an exemplary component diagram of a software framework for implementing a social services system according to an exemplary embodiment.

FIG. 3 illustrates an exemplary component diagram of a software framework for implementing a social services system according to an exemplary embodiment.

FIG. 4 illustrates an exemplary method of implementing a implementing social services framework for providing and managing the provision of social services to a recipient according to a disclosed embodiment.

### DETAILED DESCRIPTION

Described herein are embodiments of a system, a machine-readable storage medium, and a method for handling complex calculations in the management of social services benefits. Disclosed embodiments provide a computer-implemented system for executing a services management system for calculating gross benefit and payment amounts of service benefits provided to a recipient. The system may include a front end server of the computer system for interfacing with a plurality of client computers and a backend server configured to execute an application controller, an entitlement controller, a gross payment controller, and a net calculation controller. The back end server may be configured to instantiate an object of the application controller. The application controller object may obtain data related to specific services to be provided to a services recipient from the front end server. In response to a remote function call from the application controller, the back end server may instantiate an object of the gross entitlement controller, using data obtained from the application controller application. The back end server may be configured to use processes called by the gross entitlement controller object to calculate a gross monetary amount of services that the recipient is entitled to receive; and instantiate a gross payment controller object. The gross payment controller object may call and use processes to calculate a gross monetary amount of services that the recipient is to be paid. The back end server may instantiate a net calculation object. The back end server may be configured to use processes called by the net calculation object to calculate a gross monetary amount of services that the recipient is to be paid. The back end server may be configured to store data related to the net monetary amount to be paid to the recipient in an object related to the recipient.

Similarly, a method for executing a services framework may include instantiating, by a processor, an object of an application controller process. The application controller may obtain data related to specific services to be provided to a services recipient from the front end server. In response to a remote function call from the application controller, an object of the gross entitlement controller may be instantiated using data obtained from the application controller application. The gross entitlement controller object may call processes to calculate a gross monetary amount of services that the recipient is entitled to receive. A gross payment controller object may be instantiated. The gross payment controller object may use processes called by the gross payment controller object to calculate a gross monetary amount of services that the recipient is to be paid. A net calculation object may be instantiated that will call processes to calculate a gross monetary amount of services that the recipient is to be paid. The net monetary amount to be paid to the recipient in an object related to the recipient may be stored.

A machine-readable storage medium embodying computer program instructions for implementing a method for executing a services management system is also disclosed.

Returning to the example of social services, social services are commonly provided by governmental agencies in cooperation with service providing business partners, such as private food pantries, soup kitchens, government-run health facilities, or private healthcare providers. The provision of social services, or simply benefits, is typically accomplished according to a social services plan developed for the requestor. For example, a requestor may be temporarily out of work and may need food stamps to feed his children and medical coverage for himself and his family, while another requestor may be homeless and need access to a shelter, clothing and food. Due to their circumstances, these two requestors may have differing status and, as a result, may require different plans for coordinating the benefits provided to each. The government social services office or department may formulate different social services plans for each of the requestors. Once the social services plan is developed (and approved), it may be implemented. Of course, other services such as scheduled bank account payments, or private corporation pension payments, or non-government entity charity payments or other pension plans may also be made according to a payment plan or, even a deduction plan in the case of overpayments.

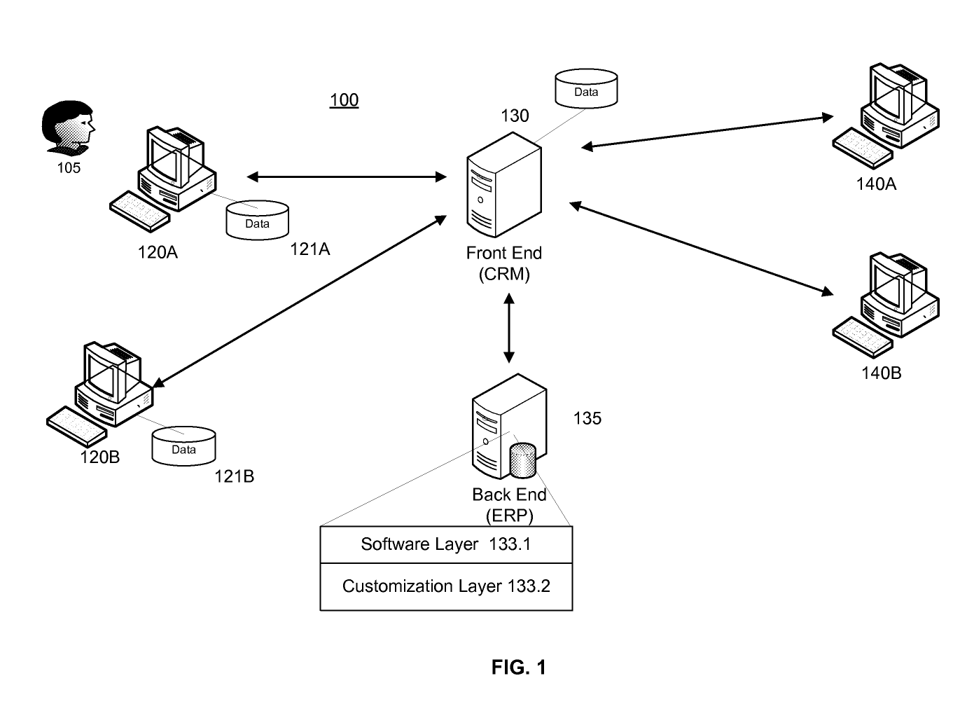

In order to manage the provision of the services benefits, a number of processes may be executed to provide the determination of the final monetary amounts to be provided. FIG. 1 illustrates an exemplary computer system for implementing a services management system. The system 100 may comprise a plurality of clients 120A and 120B, a front end server 130, a backend server 135, and a plurality of service partners 140A and 140B. Each client 120A-B may include a data storage 121A-B or be a terminal connected to the front end server 130 to allow a requestor/recipient 105 to interact with the system 100. The requestor/recipient 105 may provide information by interacting with a graphical user interface to the client 120A identifying the benefit(s), e.g., food stamps, meal tickets, healthcare, transportation, shelter and the like, the requestor/recipient 105 wishes to receive. Using software embodied on a storage device within any of computer 120A, a data storage 121A, or on server 130, a service plan may be generated based on electronic forms provided to the client 120A from either data storage 121A or front end server 130. However, each of clients 120A-B may be located in different jurisdictions, such as a different country, or in a different state, or county within a state, all of which may have different eligibility requirements for obtaining services and different approval rules for granting approval of the requested services. Therefore, the front end server 130 may provide a customized rule set retrieved from a data storage to generate the correct social services plan for the requester. The front end server 130 may execute a customer relationship management (CRM) application via the clients 120A or 120B to facilitate the requesting and approving process for the requestor/recipient 105. The front end server 130 may also communicate with a back end server 135 that may also, or instead of front end server 130, maintain the customized rule sets applicable to the different evaluations performed in the process. An exemplary software architecture of the software layer 133.1 may include a basic application framework that facilitates the creation of a services plan, such as social services plan, and computer executable instructions for calculating data related to the services plan. For example, when creating a social services plan, calculations may be performed that compute gross entitlement amounts, gross payment amounts, and the net payments due to the recipient. At various stages of the application and calculation processes, the software layer 133.1 may make calls to the customization layer 133.2. For example, the customized rule set may be retrieved by the front end server 130 from a software layer 133.1 and/or a customization layer 133.2 of the back end server 135. Of course, the customized rule sets may be distributed between the front end server 130 and the back end server 135. The customization layer 133.2 may contain customized rule sets for each jurisdiction.

The application and calculation processes may cause the instantiation of computer objects that represent the different phases of the calculation process, such as the gross entitlement calculation, the gross payment calculation, and the net calculation. An object may be a data structure that may include data fields and functional computer code that may be executed by a processor. The executable code may cause the processor interact with data in the object and with data in other objects. Objects may be defined, created, and updated by users. Some objects, such as standard roles, may be delivered with the software. Typically, objects may be classified according to an object type, and objects that belong to the same object type may share characteristics and may contain certain types of information. Generally, the application and calculation processes may be implemented as a software component, which is unit of software. Commonly, a component is considered the smallest unit that may be produced, delivered, installed, and maintained in a software architecture of a computer system.

The customization layer 133.2 may provide specific algorithms stored as computer program instructions in machine readable storage media for calculation of entitlements and payments including net calculations according to rules. The computer program instructions in the software layer 133.1 may cause a processor to implement functions stored within the customization layer 133.2, such as customizable rule sets for determining an amount of services a recipient is entitled to receive, and how a recipient may be paid according to a services plan (SP). Another type of plan called a deduction plan (DP) may also be implemented. The DP may, for example, be used to deduct any earlier overpayments from future payments to a recipient.

The customization layer 133.2 may be developed and maintained by an end user. This allows the end user to modify any rule sets as changes occur in the criteria related to the payment of the services. In addition, as new services are provided, the end user may generate new, or updated, rule sets that are called by the software layer 133.1. The services agency, or end user, may use rule engines, as known in the computer science field and provided by vendors such as SAP® and the like, to customize the rule sets in the customization layer 133.2. Alternatively to using a rules engine, the customized rule sets in customization layer 133.2 may be formulated and hard coded, or generated in some other manner.

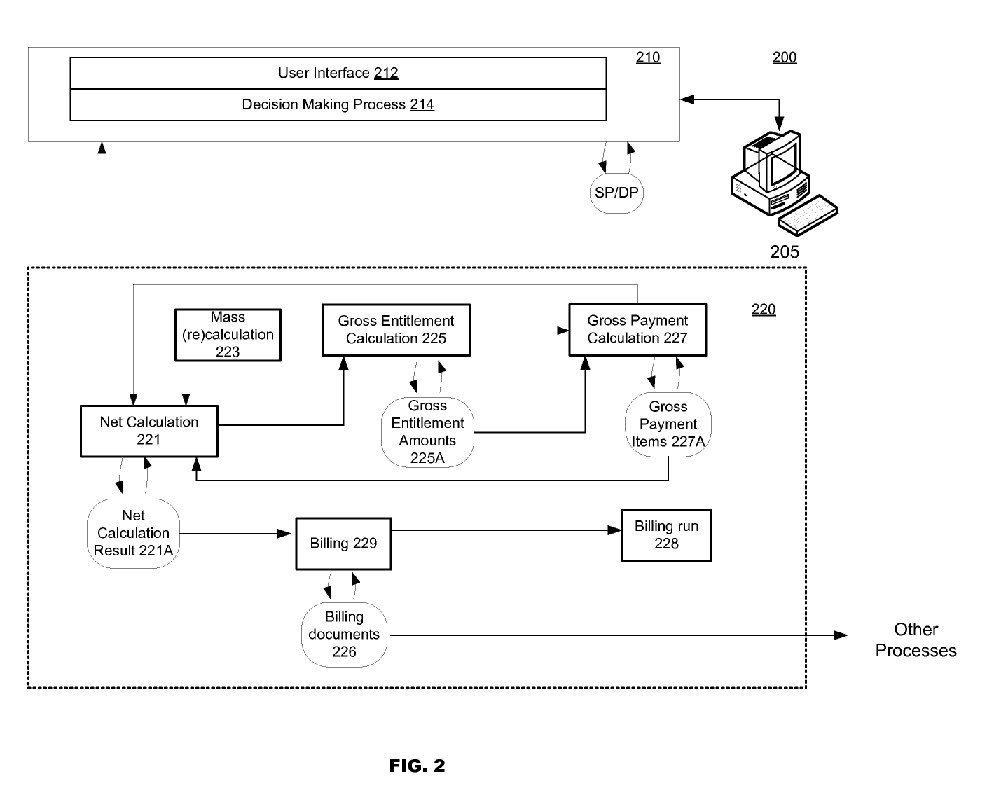

FIG. 2 illustrates an exemplary component diagram of a software architecture for implementing a services management system according to an exemplary embodiment. A services management system 200 may comprise a front end server 210 on which executes a computer application, such as a customer relationship management (CRM) solution, and a backend server 220 on which may execute an enterprise resource planning (ERP) system application. The front end server 210 computer application may execute a user interface component 212 and a decision making process component 214. The decision making process component 214 may execute program instructions based on inputs received from the user interface component 212 that may utilize the custom rule sets described above and generate a services plan or a deduction plan.

The back end server 220 may execute a number of software components, such as a net calculation component 221, a mass calculation component 223, a gross entitlement calculation component 225, a gross payment calculation 227, a billing component 229, and billing run component 228.

After a services plan is approved, it may be executed. To minimize repeated communication occurrences between the front end and the backend, a net calculation component may obtain data from the front end via a remote function call for implementation of a particular services plan or deduction plan (i.e., services plan). Using the obtained data, the net calculation component 221 provides data to the gross entitlement component 225. The gross entitlement calculation component 225 using data exchanged with gross entitlement amounts 225A calculates a gross entitlement for a particular services plan (SP). Upon generation of data related to the gross entitlement of benefits for the recipient, data may be passed to the gross payment calculation component 227 from both the gross entitlement calculation component 225 and the gross entitlement amounts data 225A. The data generated by the gross payment calculation 227 may be stored in a gross payment item 227A. The net calculation component 221 may use the data stored as a gross payment item 227A to perform a net calculation that may be used for payment of the services benefit amounts to the recipient/requestor. For example, a net calculation may deduct taxes depending on the jurisdiction that are due on some of the approved benefits in the SP which may be taxable. Or, a recipient may have been overpaid for some benefits, and the next benefit payment may be reduced, or delimited, based on a deduction schedule. Results of the net calculation may be stored in the net calculation result 221A.

Another component, billing 229, may use the data from the stored net calculation result 221A to generate payment checks. Billing component 229 may generate billing documents 226 that may be provided to other functions in the back end server 220. The completion of the payment process may be performed by another component, such as, for example, billing run 228.

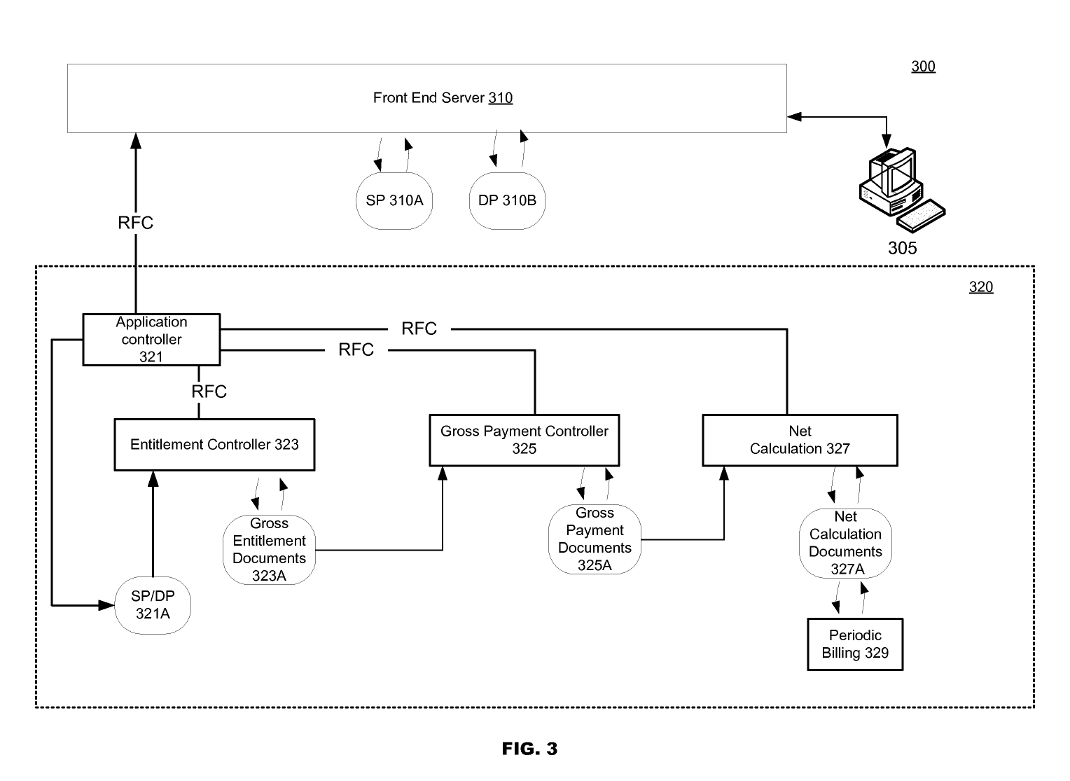

FIG. 3 illustrates an exemplary process and object diagram of a software architecture for implementing a social services framework according to an exemplary embodiment. A benefit of the disclosed embodiments is that the back end server provides a single point of contact for the front end server. The single point of contact retrieves data that may be used by the back end server to perform calculations related to the gross entitlement, the gross payment and the net calculation.

In another embodiment, the exemplary software architecture 300 comprises a front end server 310 and a back end server 320. The front end server 310 may execute a customer relationship management (CRM) computer application to take advantage of the functionality of the application, and connectivity of the existing interfaces when managing the services. The front end server 310 may interface with a client computer 305 that may provide data related to a service requestor/recipient. Using this data, processes executing on the front end server 310 may generate a services plan (SP) 310A and/or a deduction plan (DP) 310B corresponding to the service requestor/recipient.

The back end server 320 may execute an enterprise relationship planning (ERP) system application to take advantage of the functionality of the application, and connectivity of the existing interfaces for calculation of the benefits and management of paying the benefits. The back end server 320 may execute a number of processes based on computer objects instantiated for a particular SP 310A and/or DP 310B. The back end server 320 may instantiate an application controller 321 object, an entitlement controller 323 object, a gross payment calculator 325 object, and a net calculation 327 object.

After generation of the SP 310A and DP310B as computer objects, the front end server 310 may release SP and DP objects as well as others related to the SP and DP objects, such as business partners and products. Business partners may be those that provide the services to the recipient, such as bank, professional organization, lending organization, a day care provider, healthcare professional, housing landlord and the like. This data is available to the backend server 320.

A single point of contact may be maintained to minimize the communication between the front end server 310 and the back end server 320. The application controller 321 may be instantiated according to a customized synchronization schedule established by the end user. For example, the application controller object 320 can be instantiated every hour or at the end of the day, when there likely is less load on the front end server 310 and backend server 320. Once instantiated, the application controller 321 via a remote function call may obtain data from the front end server 310. For example, computer objects related to the business partners, products and the SP 310A and DP 310B may be replicated from the front end server 310 to the back end server 320. The instantiated application controller 321 object may store the data related to a number of differing business partners, products and SPs and/or DPs. For example, stored data may include data, such as business partner name and location, price for services, and recipient name, and location, and cost limits and the like.

Processes executed by the application controller 321 may generate respective remote function calls (RFC) to the entitlement controller 323, the gross payment controller 325 and the net calculation 327. The application controller 321 may cause an instantiation of an entitlement controller 323 object to execute processes related to a social services recipient. The application controller 321 may provide, or cause to be provided, data related to a recipient's SP or DP from SP/DP object 321A to the instantiation of the entitlement controller 323 object. Processes operating based on the instantiation of the entitlement controller 323 object may generate, and/or use data within gross entitlement documents 323A to determine the monetary amount of social benefits a recipient is entitled to receive. The instantiated entitlement controller 323 object may call processes that perform calculations to determine, for example, the amount of services that the recipient is entitled to receive, and the duration of the benefit. The called processes may also generate other data related to a social service entitlement, such as codes for the reason for the entitlement, e.g., pregnancy, birth of child, short-term disability. The calculation results and other data may be stored in a gross entitlement document as part of the gross entitlement documents 323A. Completion of the calculations may cause the instantiated entitlement controller 323 object to output of an indication to the application controller 321 that the processes of calculating a gross entitlement for the respective recipient have completed execution. Upon receiving the indication that the instantiated entitlement controller 323 object has completed execution, the application controller 321 may generate an instance of a gross payment controller 325 object via a remote function call. The gross payment controller 325 object may utilize data stored as a gross entitlement document 323A by the entitlement controller 323 object. The gross payment controller 325 object may call processes to make calculations of the gross payments of monetary amounts due to be paid to the recipient. The calculations may use data from the gross entitlement documents 323A. The calculation results of the gross payment controller 325 may be stored in a gross payment document as part of the gross payment documents 325A.

Completion of the calculations may cause the instantiated gross payment controller 325 object to output of an indication to the application controller 321 that the processes of calculating a gross payment for the respective recipient have completed execution. Upon receiving the indication that the instantiated gross payment controller 325 object has completed execution, the application controller 321 may generate an instance of a net calculation 327 object via a remote function call. The net calculation 327 object may call processes that perform net calculations of the payments that will be due to the recipient. For example, taxable benefits may be appropriately taxed, and the any deductions that were indicated in the data retrieved from the social deduction plan SP/DP 321A may be withheld. The results of the net calculation 327 object processes may be stored in the net calculation documents 327. The billing processes may be implemented via a periodic billing object 329 that may use the net calculation documents 327 to perform the billing and payment of the services for the recipient.

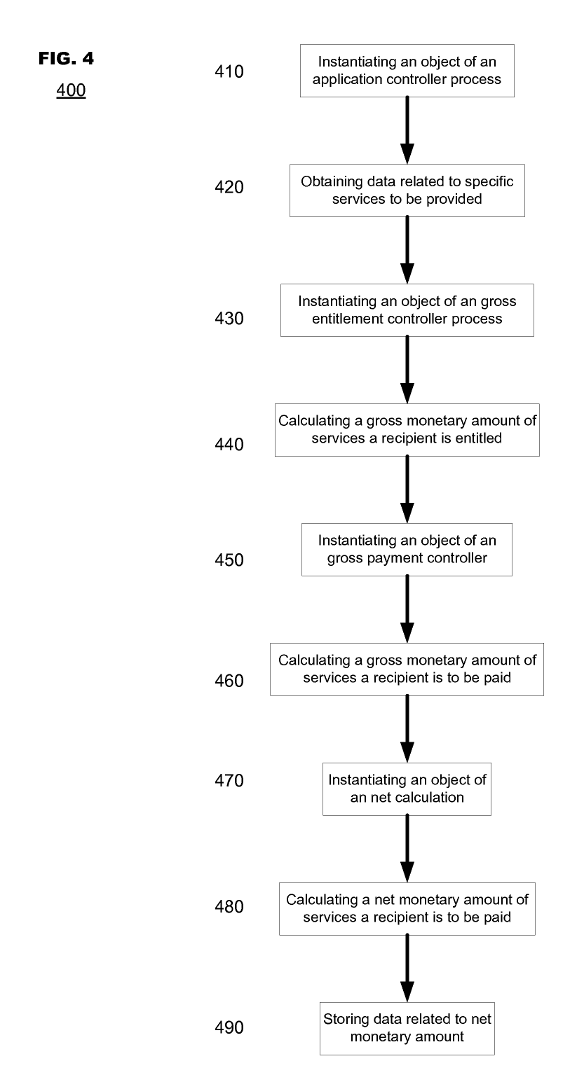

FIG. 4 illustrates an exemplary method of implementing a services management system for providing and managing the provision of services to a recipient according to a disclosed embodiment. The process 400 begins at step 410 by instantiating an object of a application controller process, for example, by a processor executing on the back end server a processor. An application controller object executing a process on the processor may, at step 420, obtain data related to specific services to be provided to a services recipient from the front end server. In response to a remote function call from the application controller, at step 430, an object of the gross entitlement controller may be instantiated using data obtained from the application controller application. At step 440, using processes called by the gross entitlement controller object, a gross monetary amount of services that the recipient is entitled to receive may be calculated. A gross payment controller object may be instantiated (Step 450). The gross payment controller object, at step 460, may call processes to calculate a gross monetary amount of services that the recipient is to be paid. At step 470, a net calculation object may be instantiated. The net calculation object using called processes may calculate a gross monetary amount of services that the recipient is to be paid. (Step 480). At step 490, the data related to the net monetary amount to be paid to the recipient in an object related to the recipient may be stored.

The exemplary method and computer program instructions may be embodied on a machine readable storage medium such as a computer disc, optically-readable media, magnetic media, hard drives, RAID storage device, and flash memory. In addition, a server or database server may include machine readable media configured to store machine executable program instructions. The features of the disclosed embodiments may be implemented in hardware, software, firmware, or a combination thereof and utilized in systems, subsystems, components or subcomponents thereof. When implemented in software, the elements of the disclosed embodiments are programs or the code segments used to perform the necessary tasks. The program or code segments can be stored on machine readable storage media. The “machine readable storage media” may include any medium that can store information. Examples of a machine readable storage medium include electronic circuits, semiconductor memory device, ROM, flash memory, erasable ROM (EROM), floppy diskette, CD-ROM, optical disk, hard disk, fiber optic medium, or any electromagnetic or optical storage device. The code segments may be downloaded via computer networks such as Internet, Intranet, etc.

Although the invention has been described above with reference to specific embodiments, the invention is not limited to the above embodiments and the specific configurations shown in the drawings. For example, some components shown may be combined with each other as one embodiment, or a component may be divided into several subcomponents, or any other known or available component may be added. The operation processes are also not limited to those shown in the examples. Those skilled in the art will appreciate that the invention may be implemented in other ways without departing from the spirit and substantive features of the invention. For example, features and embodiments described above may be combined with and without each other. The present embodiments are therefore to be considered in all respects as illustrative and not restrictive. The scope of the invention is indicated by the appended claims rather than by the foregoing description, and all changes that come within the meaning and range of equivalency of the claims are therefore intended to be embraced therein.

What is claimed is:

1. A computer system for implementing a services management system for providing services to a recipient, comprising:
a front end server of the computer system for interfacing with a plurality of client computers; and
a backend server configured to execute an application controller, an entitlement controller, a gross payment controller, and a net calculation controller, wherein the back end server is configured to:
instantiate an object of the application controller;
obtain, by the application controller object, data related to specific services to be provided to a services recipient from the front end server;
in response to a remote function call from the application controller, instantiate an object of the gross entitlement controller, using data obtained from the application controller application;
calculate a gross monetary amount of services that the recipient is entitled to receive by a process called by the gross entitlement controller object;
instantiate a gross payment controller object;
calculate a gross monetary amount of services that the recipient is to be paid by a process called by the gross payment controller object;
instantiate a net calculation object;
calculate a net monetary amount of services that the recipient is to be paid by a process called by the net calculation object; and
store data related to the net monetary amount to be paid to the recipient in an object related to the recipient.

2. The computer system of claim 1, wherein the backend server is further configured to:
provide a single point of communication with the front end server.

3. The computer system of claim 1, wherein the backend server is further configured to:
provide, by the application controller, data from a services plan, wherein the data from a deduction plan is obtained from the front end server via a remote function call.

4. A method for implementing a services management system for providing services to a recipient, comprising:
instantiating, by a processor executing on a processor, an object of a application controller process;
obtaining, by the application controller object executing a process on the processor, data related to specific social services to be provided to a services recipient from the front end server;
in response to a remote function call from the application controller, instantiating an object of the gross entitlement controller, using data obtained from the application controller application;
calculating a gross monetary amount of services that the recipient is entitled to receive by a process called by the gross entitlement controller object;
instantiating a gross payment controller object;
calculating a gross monetary amount of services that the recipient is to be paid by a process called by the gross payment controller object;
instantiating a net calculation object;
calculating a net monetary amount of services that the recipient is to be paid by a process called by the net calculation object; and
storing data related to the net monetary amount to be paid to the recipient in an object related to the recipient.

5. The method of claim 5, further comprising:
providing, by the application controller, data from a services plan, wherein the data from the deduction plan is obtained from the front end server via a remote function call.

6. A machine-readable storage medium embodied with program instructions for causing a computer to execute a method for implementing services management system for providing services to a recipient, the method comprising:
instantiating, by a processor executing on a processor, an object of an application controller process;
obtaining, by the application controller object executing a process on the processor, data related to specific services to be provided to a services recipient from the front end server;
in response to a remote function call from the application controller, instantiating an object of the gross entitlement controller, using data obtained from the application controller application;
calculating a gross monetary amount of services that the recipient is entitled to receive by a process called by the gross entitlement controller object;
instantiating a gross payment controller object;
calculating a gross monetary amount of services that the recipient is to be paid by a process called by the gross payment controller object;
instantiating a net calculation object;
calculating a net monetary amount of services that the recipient is to be paid by a process called by the net calculation object; and
storing data related to the net monetary amount to be paid to the recipient in an object related to the recipient.
